(19) United States
(12) Patent Application Publication
(10) Pub. No.: US 2008/0166900 A1
(43) Pub. Date: Jul. 10, 2008

(54) Structure of wire output

(75) Inventor: Peter Chang, Taipei Hsien (TW)

Correspondence Address: BIRCH STEWART KOLASCH & BIRCH, PO BOX 747, FALLS CHURCH, VA, 22040-0747, US

(73) Assignee: Andyson International Co., Ltd.

(21) Appl. No.: 11/649,235

(22) Filed: Jan. 4, 2007

(51) Int. Cl. H01R 12/16; H01R 13/46

(52) U.S. Cl. 439/76.1; 174/59

(57) ABSTRACT

A structure of wire output is mainly composed by a main board wire set and a peripheral wire set; the characteristic lies in: the peripheral wire set is composed of a set of electric conducting wires connected to input/output terminals of a circuit board, which comprises 4 to 8 sockets that are connected to electric conducting wires via printed circuits on the circuit board. Accordingly, the said structure of wire output provides the computer with enhanced connection to various peripherals and the power supply with aesthetic wire arrangement whiling attaining to reduce quantity of the electric conducting wires to a reasonable level.

### BACKGROUND OF THE INVENTION

I. Field of the Invention

The present invention relates to a “structure of wire output” for power supply, especially, to a “structure of wire output” for the computer power supply that integrates on a circuit board 4 to 8 sockets for connection with the peripherals so as to limit quantity of electric conducting wires to a reasonable level that facilitates plug and pull peripheral connectors and outlines roominess of the computer housing.

II. Description of the Prior Art

The computer is so popular that almost every household and/or business unit has one. With regard to a computer, it is mainly built with CPU, main board, interface cards (e.g. display card, sound card and etc.), hard disks, Floppy disks and CD-ROM drives and so on. However, the computer would be just an inert box without a power supply, which is absolutely vital to operations of a computer. The power supply typically needs to supply different voltages so as to meet the currents used by different peripherals connected to the computer. The structure of wire output (see FIG. 5) adopted by the power supply 50 of the prior art, which comprises a main board wire set 52 and several peripheral wire sets 53, needs to pass through a wire output aperture 511 on casing 51 of the power supply 50 so as to supply power to computer and connected peripherals. Specifically, there is one main board wire set and are five peripheral wire sets composed of more than twenty-four electric conducting wires that pass through the wire output aperture 511. The said structure with so many wires proposes higher cost, as a result. In addition, the computer housing chucked up with so many wires would hinder repair and/or assembly. In terms of EMI shielding (the prior technology, not illustrated), each of the main board wire set 52 and peripheral wire sets 53 must be installed with one EMI shielding structure. Such repeated installations provoke, no doubt, extravagance.

In view of the foregoing drawbacks of the power supply of the prior art, the present invention aims at providing an innovative structure of wire output for the computer power supply.

Main objective of the present invention is to provide a structure of wire output for the computer power supply that reduces the quantities of electric conducting wire without compromising enhancability of the computer so as to have better usability and outline roominess of the computer housing.

Secondary objective of the present invention is to provide a structure of wire output for the computer power supply where an EMI shielding box or filter chip can be installed on input/output terminals of the circuit board comprised in the peripheral wire set so as to enhance practicability of the power supply and reduce cost of the EMI shielding.

Furthermore, the present invention also aims at providing a structure of wire output for the computer power supply where one or more than one LED lamp can be installed on circuit board so as to be served as an indicator or illuminant.

### SUMMARY OF THE INVENTION

To achieve the foregoing objectives, the present invention provides a power supply casing that has an aperture drilled on one wall so as to allow the structure of wire output, composed of a main board wire set and a peripheral wire set, passing through; the characteristic lies in: the peripheral wire set is composed of a set of electric conducting wires connected to input/output terminals of a circuit board, which comprises 4 to 8 sockets that are connected to electric conducting wires via printed circuit on the circuit board.

According to the foregoing structure, an EMI shielding box or filter chip is installed at input/output terminals of the circuit board; and, one or more than one LED lamp is installed at appropriate position on the circuit board and forms an electric loop with electric of the circuit board.

When the foregoing structure is assembled for use, in addition to one main board wire set, it comprises one peripheral wire set that is composed of 4 to 6 electric conducting wires (including 12V, 5V, 3.3V, ground and signal wire each) so as to reduce the quantities of electric conducting wires for cost saving. While limiting quantities of electric conducting wires to necessary level, the structure of wire output of the present invention provides tidy and aesthetic outlook in addition to giving more space in the computer housing that facilitates the repair and/or assembly

Because the present invention limits quantity of the peripheral wire set to one, only one EMI shielding box or filter chip, which is installed on input/output terminals of the circuit board that approach the power cords, is needed to fulfill EMI shielding to all the peripherals that are connected to the power supply. The present invention attains to reduce the cost without comprising effects of the EMI shielding. In addition, the LED lamp, which is installed at appropriate position on the circuit board, can be served as an indicator when it forms electric loop with one of the printed circuits belong to the sockets. Moreover, the said LED lamp can be served as an illuminant facilitating repair and/or assembly in the computer housing on condition that it is of high energetic white light and forms electric loop with electric of input/output terminals.

### BRIEF DESCRIPTION OF THE DRAWINGS

FIG. 1 is a three-dimensional view showing assembly of the present invention.

FIG. 2 is a decomposed view showing the peripheral wire set of another embodiment of the present invention.

FIG. 3 is a three-dimensional view showing assembly of the peripheral wire set of FIG. 2.

FIG. 4 is a three-dimensional view showing assembly of an embodiment of the present invention.

FIG. 5 is a three-dimensional view showing appearance of the power supply of the prior art.

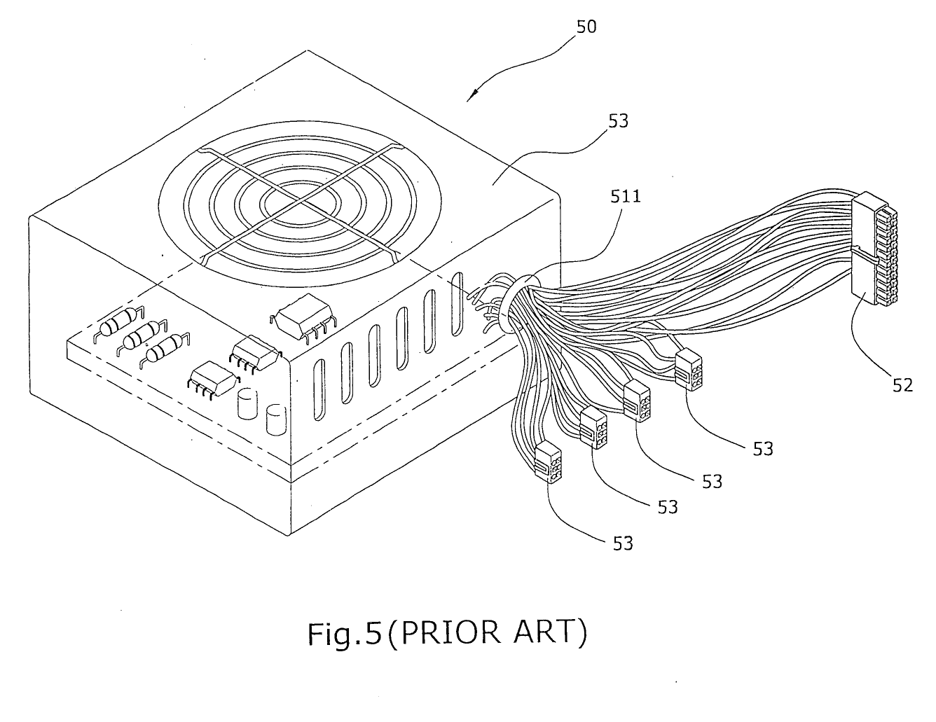

### DESCRIPTION OF THE PREFERRED EMBODIMENTS

Desirable structure, assembly and features of the present invention will be better understood from the detailed description and drawings that follow, in which various embodiments of the disclosed invention are illustrated by way of example.

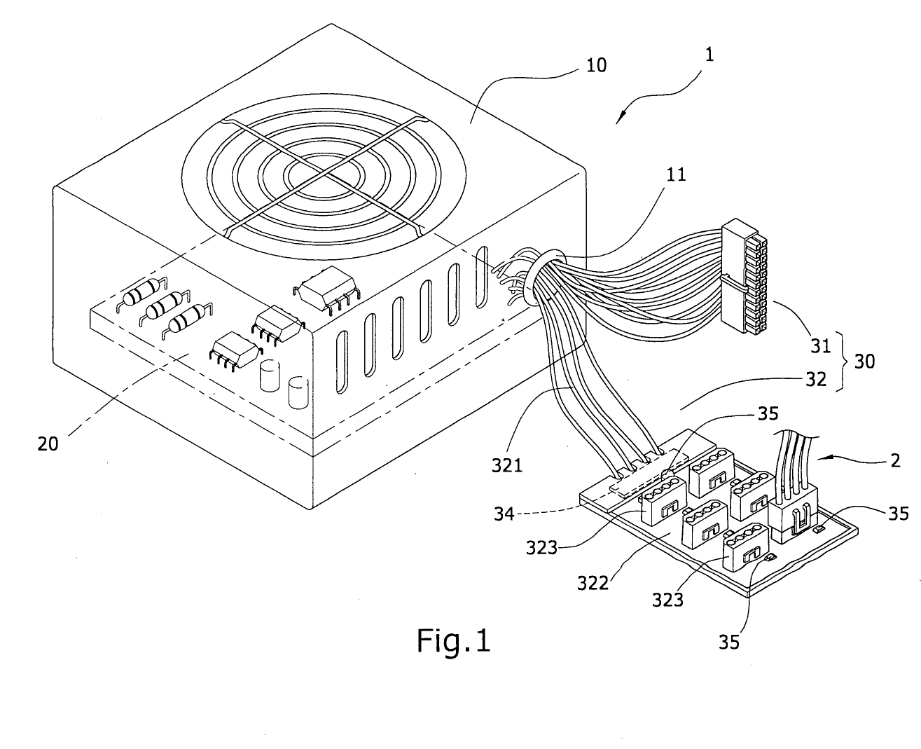

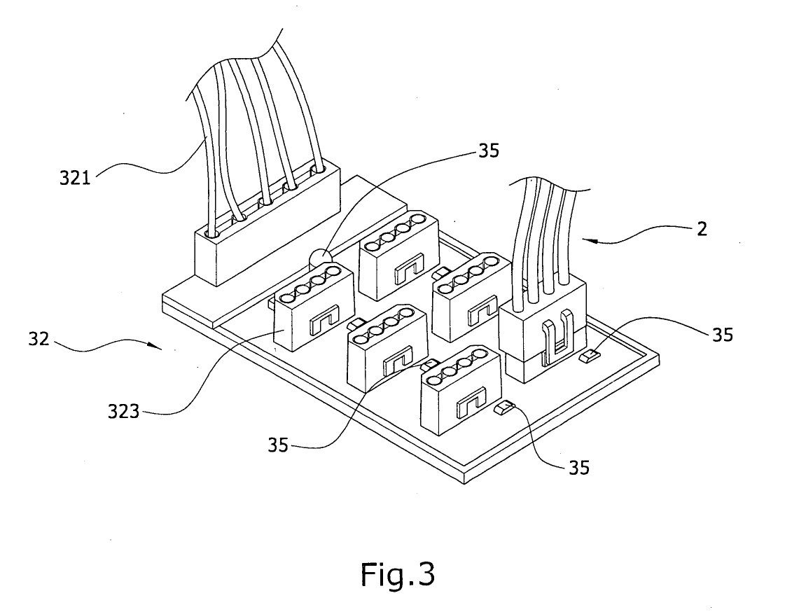

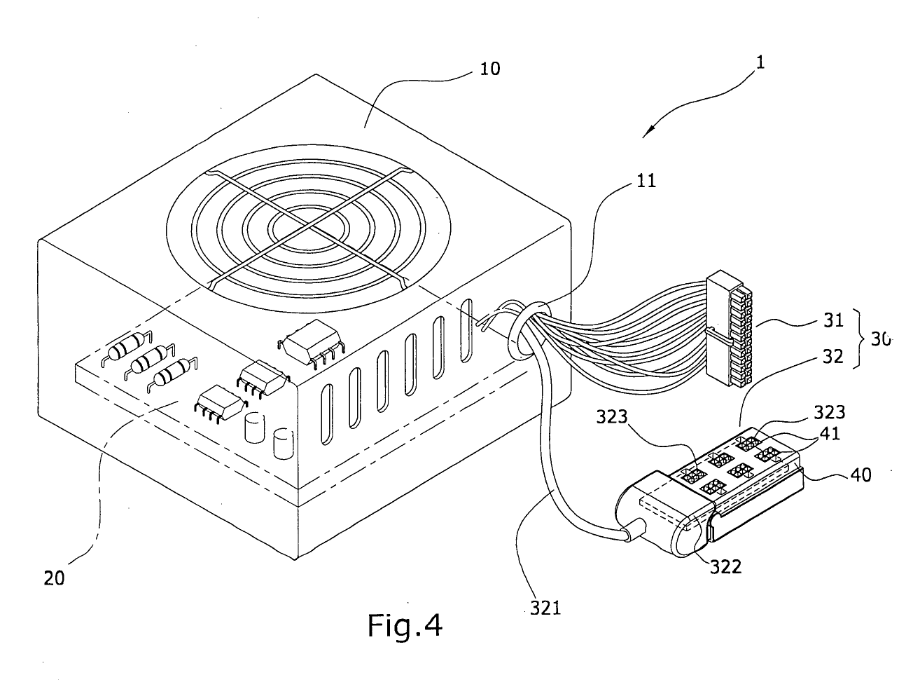

With reference to FIG. 1 to 3, the power supply 1 has power circuit 20 of the transformer and constant voltage regulator in its casing 10, where has an aperture drilled on one wall so as to be served as wire output aperture 11, where allows the structure of wire output 30 connected to output terminal of the power circuit 20 passing through so as to supply the computer with necessary power. The structure of wire output 30 is composed of a main board wire set 31 and a peripheral wire set 32. The characteristic lies in: the peripheral wire set 32 is an assembly of a plurality of electric conducting wires 321, which are connected to the circuit board 322 at its input/output terminals 3221, and a circuit board 322, which comprises 4 to 8 socket 323 corresponding to connectors of the cable assemblies 2 adopted by various peripherals (see FIGS. 1 and 3). Also, the circuit board 322 of the peripheral wire set 32 is installed in a hand-held casing 40 (see FIG. 4), which comprises a plurality of openings 41 allowing the sockets 323 surfacing. Design of this hand-held casing 40 not only emphasizes on usability but also aesthetics. Consequently, a power supply that comprises the structure of wire output of the present invention can distinguish value of a computer that is equipped with it.

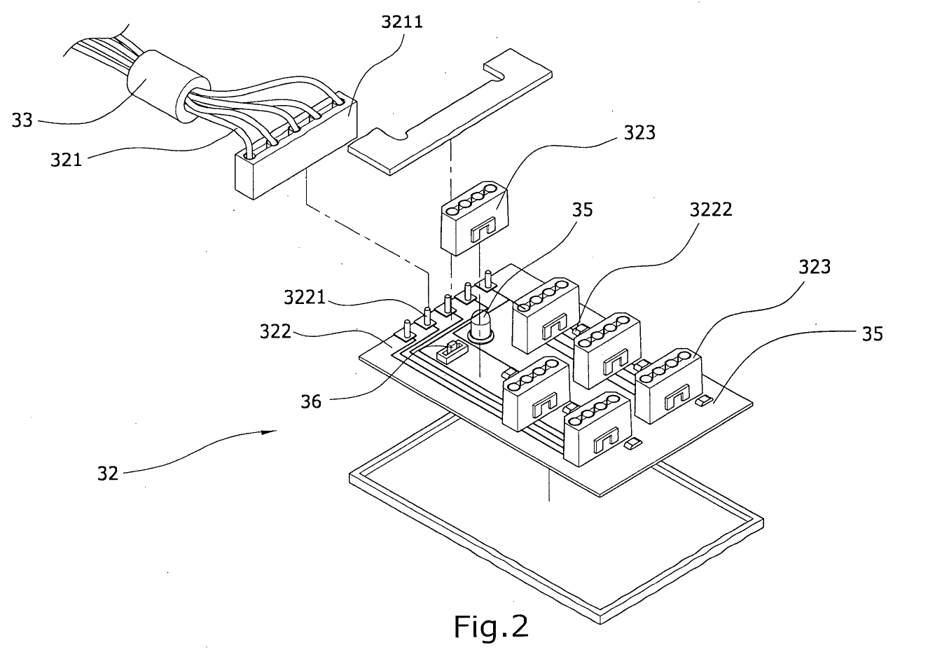

According to the foregoing description, connection of the electric conducting wires 321 and the circuit board 322 can be made by soldering the electric conducting wires 321 to input/output terminals 3221 (see FIG. 1), bundling the electric conducting wires 321 into a connector so as to be inserted into pins on the circuit board (see FIG. 2), or connecting a pair of male and female connectors to electric conducting wires 321 and input/output terminals of the circuit board 322 (not illustrated) respectively.

According to the foregoing structure, it needs only one EMI shielding box 33 or filter chip 34 to fulfill EMI shielding to the peripheral wire set 32. The EMI shielding box 33 (see FIG. 2) can be added on input/output terminals 3221 of the circuit board 322 that approach the electric conducting wires 321. The filter chip 34 (illustrated by dotted line in FIG. 1) can be built in the circuit board 322. In addition, one or more than one LED lamp 35 (see FIG. 2) can be installed at appropriate position on the circuit board 322 for indicating power conduction or illuminating internal of the computer housing. The LED lamp 35 can perform such functions as power indication and housing illumination due to it is formed into an electric loop with printed circuit 3222 or input/output terminals 3221 on the circuit board 322.

When the foregoing structure, which comprises a main board wire set 31 composed of a fixed number of wires and a peripheral wire set 32 composed of 4 to 6 wires for 12V, 5V, 3.3V, grounding and signal and so on, is assembled for use, the assembly can achieve in reducing the wire cost because the electric conducting wires output from casing 10 of the power supply 1 are limited to a reasonable quantity that meets necessary requirements of the computer. As a result, while providing convenient connection of the computer and various peripherals, the structure of output wire presents a tidy and aesthetic outlook that successfully outlines the roominess of the casing 10.

Moreover, the present invention initiates an EMI shielding structure that provides the peripherals with effective EMI shielding without imposing a heavy cost. In view the electric conducting wires 321 connected to peripherals are confined to reasonable quantity and bundled into one peripheral wire set 32, it only requires one EMI shielding box 33 or filter chip 34 installed on the existing circuit board 322 to fulfill EMI shielding to all the peripherals that are connected to the power supply. Installation of the EMI shielding box 33 or filter chip 34 is like installing its one end on input/output terminals 3221 of the circuit board that approach the electric conducting wires 321 and connecting, at the same time, the other end to the sockets 323 where connectors of the peripherals (not illustrated) are inserted in.

According to the present invention, the LED lamp 35 can also be installed at appropriate position on the circuit board to indicate the power connection as well as illuminate internal of the computer housing for repair and/or assembly. When the LED lamp 35 is connected to one of the printed circuits belong to the sockets 323 to form an electric loop, the glint of LED lamp reveals power connection of the sockets 323. When the LED lamp 35 of high energetic white lights is connected to input/output terminals 3221 of the circuit board to form an electric loop, the LED lamp is served as illuminant to light up internal of the computer housing for repair and/or assembly. Preferably, installing a switch between the LED lamp and the connected power so as to control the LED lamp.

While the present invention is susceptible to various modifications and alternative forms, specific embodiments have been shown by way of example in the drawings and described in detail herein. However, it should be understood that the invention is not intended to be limited to the particular form disclosed. Rather, the invention is to cover all modifications, equivalents, and alternatives falling within the spirit and scope of the invention as defined by the appended claims.

To sum up, the present invention provides an authentic “structure of output wire” that has advantages of cost effectiveness, enhanced usability and aesthetics so as to possess the “practicability” and the “advancement” of the industry.

What is claimed is:

1. A structure of wire output, which is constructed by drilling an aperture on one wall of a power supply casing so as to allow the electric conducting wires inside the casing passing through, comprises a main board wire set and a peripheral wire set; the characteristic lies in:
The peripheral wire set is composed of a set of electric conducting wires that are installed on input/output terminals of the circuit board and a circuit board that comprises 4 to 8 sockets, wherein connection of the electric conducting wires and the circuit board are made via printed circuit on the circuit board.

2. The structure of wire output of claim 1, wherein the electric conducting wires are soldered on input/output terminals of the circuit board.

3. The structure of wire output of claim 1, wherein the electric conducting wires bundled into a connector, whose sockets can be inserted in by pins on input/output terminals of the circuit board for connection.

4. The structure of wire output of claim 1, wherein the electric conducting wires are bundled into a connector and the input/output terminals of the circuit board is connected to another connector via an electric conducting wire. The electric conducting wires are connected to circuit board when those two connectors are contacted to each other.

5. The structure of wire output of claim 1, wherein an EMI shielding box or filter chip is installed on input/output terminals of the circuit board where approach the electric conducting wires.

6. The structure of wire output of claim 1, wherein one or more than one LED lamp that is installed at appropriate position on the circuit board is connected to printed circuit thereon to form an electric loop.

7. The structure of wire output of claim 6, wherein the LED lamp is an indicator.

8. The structure of wire output of claim 6, wherein the LED lamp is an illuminant emitting white light.
